(19) United States
(12) Patent Application Publication
(10) Pub. No.: US 2013/0326155 A1
(43) Pub. Date: Dec. 5, 2013

(54) SYSTEM AND METHOD OF OPTIMIZED USER COHERENCE FOR A CACHE BLOCK WITH SPARSE DIRTY LINES

(71) Applicant: Abhijeet Ashok Chachad, Plano, TX (US)

(72) Inventor: Abhijeet Ashok Chachad, Plano, TX (US)

(73) Assignee: Texas Instruments Incorporated, Dallas, TX (US)

(21) Appl. No.: 13/483,813

(22) Filed: May 30, 2012

(51) Int. Cl. G06F 12/08

(52) U.S. Cl. 711/143; 711/E12.017

(57) ABSTRACT

A system and method of optimized user coherence for a cache block with sparse dirty lines is disclosed wherein valid and dirty bits of each set are logically AND'ed together and the result for multiple sets are logically OR'ed together resulting in an indication whether a particular block has any dirty lines. If the result indicates that a block does not have dirty lines, then that entire block can be skipped from being written back without affecting coherency.

### TECHNICAL FIELD

This disclosure relates generally to caches. More specifically, this disclosure relates to an efficient system and method of user initiated fast writeback of cache blocks.

### BACKGROUND

Many single-core and multi-core processor applications execute tasks requiring a user initiated writeback of a cache block. In many situations, the block being written back may not have all dirty lines. In fact, it is quite common for applications to do a user coherence writeback operation on a large cache block having a relatively very few number of dirty lines. This unnecessarily results in the cache controller checking each line in the cache for Valid and Dirty status—even if the cache line is clean. Only dirty lines need to be evicted (i.e. written back) in order to maintain cache coherency. Consequently, many cycles are wasted checking line status if only a few dirty lines exist—particularly since the time taken by the cache controller is directly dependent on the block size and the entire size of the cache.

### BRIEF DESCRIPTION OF DRAWINGS

For a more complete understanding of this disclosure and its features, reference is now made to the following description, taken in conjunction with the accompanying drawings, in which:

FIG. 1 illustrates an exemplary system that may employ the invention according to this disclosure;

FIG. 2 illustrates a caching operation for a DMA write according to this disclosure;

FIG. 3 illustrates a caching operation for a DMA read according to this disclosure;

FIG. 4 illustrates a cache practiced in accordance with the principles of the present invention; and

FIG. 5 illustrates cache controller logic in accordance with the principles of the present invention.

### DETAILED DESCRIPTION

The FIGURES and text below, and the various embodiments used to describe the principles of the present invention are by way of illustration only and should not be construed in any way to limit the scope of the invention. A Person Having Ordinary Skill in the Art (PHOSITA) will readily recognize that the principles of the present invention maybe implemented in any type of suitably arranged device or system.

It may be advantageous to first set forth definitions of certain words and phrases used throughout this patent document. The term “couple” and its derivatives refer to any direct or indirect communication between two or more elements, whether or not those elements are in physical contact with one another. The terms “include” and “comprise”, as well as derivatives thereof, mean inclusion without limitation. The term “or” is inclusive, meaning and/or. The phrase “associated with”, as well as derivatives thereof, may mean to include, be included within, interconnect with, contain, be contained within, connect to or with, couple to or with, be communicable with, cooperate with, interleave, juxtapose, be proximate to, be bound to or with, have, have a property of, have a relationship to or with, or the like. The phrase “at least one of”, when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

A discussion of organization and function of hierarchical memory architectures and multi-level caches can be found in the TMS320C6000 DSP Cache User's Guide, May 2003 and the TMS320C64x+ DSP Cache User's Guide, February 2009, both documents herein incorporated by reference in their entireties. It is to be understood that the present invention applies to any and all levels in the hierarchical memory architecture.

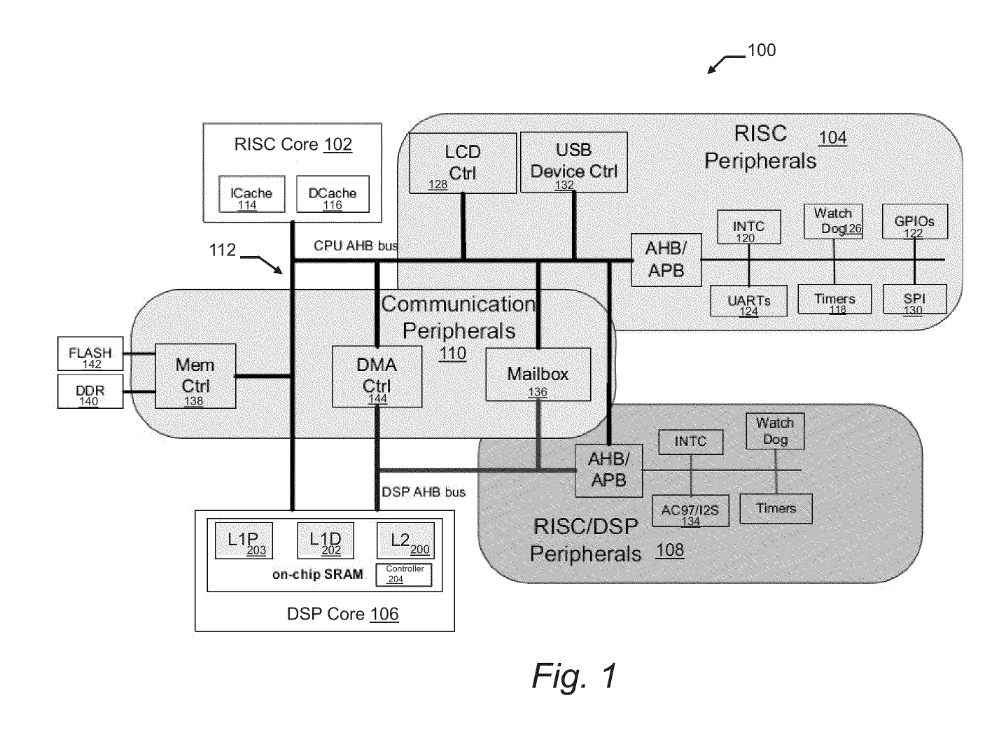

FIG. 1 illustrates an exemplary system 100 with a hierarchical memory architecture that is suitable for use with the present invention according to this disclosure. While the exemplary system 100 is illustrated as having a dual core processing system, a PHOSITA will readily recognize that the present invention is equally applicable to any uniprocessor or any multiprocessor (of any number of cores) system. The system 100 comprises a RISC Core 102, RISC peripherals 104, a DSP Core 106, shared RISC/DSP peripherals 108 and communication peripherals 110. The RISC core 102 is the central controller of the entire system 100 having access to peripherals 104, 108, and 110 and to on-chip level one cache program memory (UP) 203, level one cache data memory (L1D) 202 and level two cache memory (L2) 200 on the DSP core 106. The DSP core 106 acts as a slave to the RISC core 102 while RISC and DSP cores 102 and 106 are coupled to the peripherals preferably, although not necessarily exclusively, by a two-layer Advanced Microcontroller Bus Architecture (AMBA) bus 112, commonly used with system-on-a-chip (SoC) designs.

RISC core 102 preferably has independent instruction cache 114 and data cache 116, optimized for high-level programmability and control-driven applications.

The DSP core 106 preferably has a Harvard architecture with on-chip level one program cache memory (L1P) 203, level one data cache (L1D) 202 and level two cache (L2) 200. A PHOSITA will readily recognize that the present invention is equally applicable to a core having a Von Neumann architecture without departing from the scope or sprit of the invention. The DSP core 106 preferably has integrated variable length coding extension instructions for efficient entropy coding and a co-processor interface for hardware video accelerators.

RISC peripherals 104 support operating system needs such as timers 118, interrupt controller 120, general purpose I/O (GPIO) 122, UART 124 and watch dog timer 126. Additionally, a LCD controller 128 may be included to support a graphic user interface and video playback. A secure digital (SD) storage card (not shown) may be attached to a serial peripheral interface (SPI) 130 and connected to a host PC via USB device controller 132 for large amount of video/audio data. The RISC/DSP peripherals 108 have similar functions to the RISC peripherals 104 but may further include an AC97/I2S interface 134 for digital audio output.

Inter-core communication (IPC) between RISC core 102 and DSP core 106 provided by communication peripherals 110 utilizes a mailbox 136 for synchronization and shared memory for data. The memory controller 138 provides shared DDR-SDRAM memory 140 and Flash memory 142 for both cores 102 and 106. A DMA controller 144 is connected to both RISC and DSP cores 102 and 106 over the two-layer AMBA bus 112 having Advanced High-performance Bus (AHB) and Advanced Peripheral Bus (APB) to support multiple simultaneous DMA transfers if no resource contention exist thus speeding up bulk data transfers.

Generally, if multiple devices, such as the RISC and DSP cores 102, 106 or peripherals 104, 108, and 110, share the same cacheable memory region, cache and memory can become incoherent. For this purpose, the cache controller 204 is coupled to each of the three on-chip SRAM cache memories. In the preferred embodiment, the cache controller 204 is responsible for maintaining coherency between the L1D and L2 caches offering various commands that allow it to manually keep caches coherent.

Before describing programmer-initiated cache coherence operations, it is beneficial to first understand the snoop-based protocols that are used by the cache controller 204 to maintain coherence between a L1D cache 202 and L2 cache 200 for DMA accesses. Generally, snooping is a cache operation initiated by a lower-level memory to check if the address requested is cached (valid) in the higher-level memory. If yes, the appropriate operation is triggered.

To illustrate snooping, assume a peripheral writes data through the DMA controller 144 to an input buffer located in the L2 cache. The RISC core 102 or DSP core 106 reads the data, processes it, and writes it to an output buffer in the cache. From there, the data is sent through the DMA controller 144 to another peripheral.

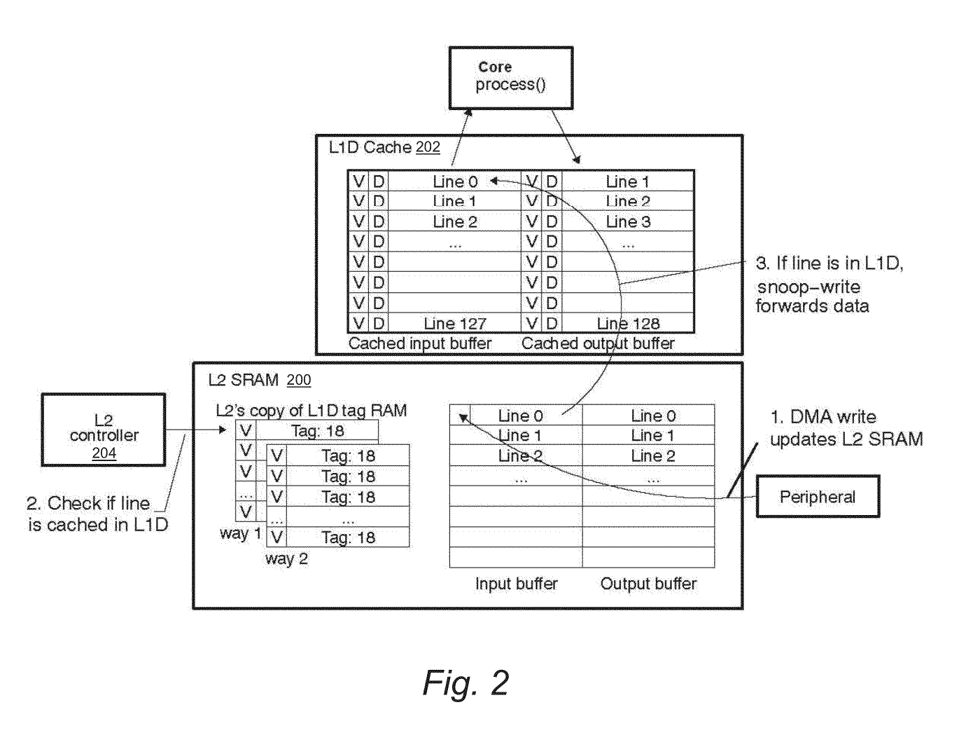

Reference is now made to FIG. 2 that depicts a caching operation for a DMA write. A peripheral 104, 108, or 110 (FIG. 1) requests a write access to a line in L2 cache 200 that maps to set 0 in L1D 202. The cache controller 204 checks its local copy of the L1D tag RAM and determines if the line that was just requested is cached in L1D cache 202 (by checking the valid bit and the tag). If the line is not cached in L1D 202, no further action needs to be taken and the data is written to memory. If the line is cached in L1D 202, the controller 204 updates the data in L2 cache 200 and directly updates L1D cache 202 by issuing a snoop-write command. Note that the dirty bit (D) is not affected by this operation.

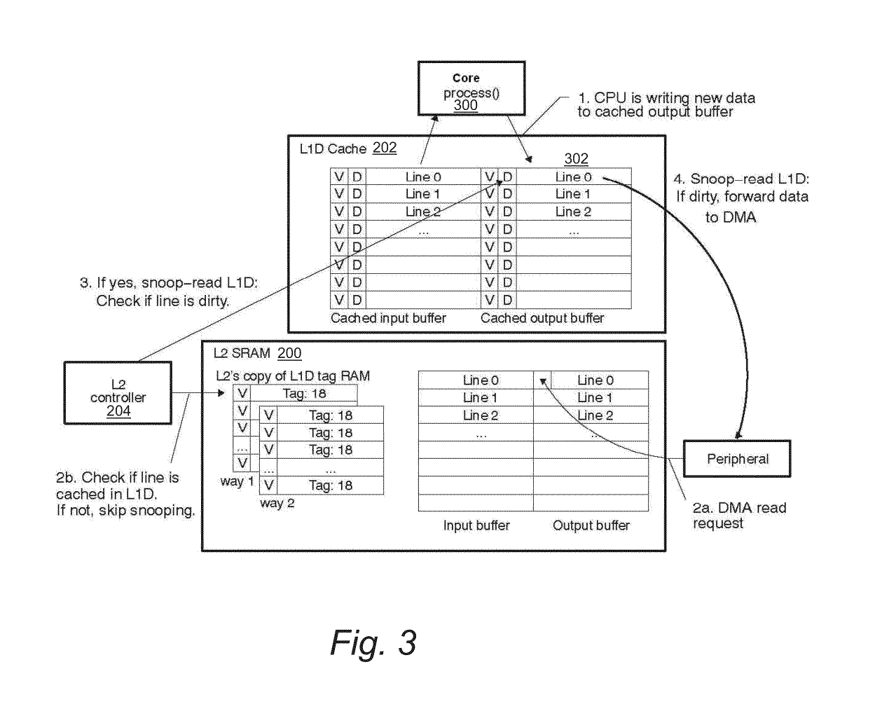

Reference is now made to FIG. 3 that depicts a caching operation for a DMA read. A process 300 in the RISC core 102 or DSP core 106 writes the result to the output buffer 302 pre-allocated in L1D cache 202. Since the buffer 302 is cached, only the cached copy of the data is updated, but not the data in L2 cache 200. When a peripheral 104, 108 or 110 issues a DMA read request through controller 144 to a memory location in L2 cache 200, the controller 144 checks to determine if the line that contains the memory location requested is cached in L1D cache 202. In the present example, it is assumed that it is cached. However, if it was not cached, no further action would be taken and the peripheral would complete the read access. If the line is cached, the controller 204 sends a snoop-read command to L1D cache 202. The snoop first checks to determine if the corresponding line is dirty. If not, the peripheral is allowed to complete the read access. If the dirty bit (D) is set, the snoop-read causes the data to be forwarded directly to the DMA controller 144 without writing it to L2 cache 200. This is the case in this example, since it is assumed that the RISC core 102 or DSP core 106 has written to the output buffer.

TABLE 1

| Coherence | | | |
|---|---|---|---|
| Operation | Operation on L2 Cache | Operation on L1D Cache | Operation on L1P Cache |
| Invalidate L2 | All lines within range | All lines within range | All lines within range |
| | invalidated (any dirty data | invalidated (any dirty | invalidated. |
| | is discarded). | data is discarded). | |
| Writeback L2 | Dirty lines within range | Dirty lines within range | None |
| | written back. All lines kept | written back. All lines | |
| | valid. | kept valid. | |
| Writeback | Dirty lines within range | Dirty lines within range | All lines within range |
| Invalidate L2 | written back. All lines | written back. All lines | invalidated. |
| | within range invalidated. | within range invalidated. | |
| Writeback All | All dirty lines in L2 | All lines within range | None |
| L2 | written back. All lines kept | invalidated All dirty | |
| | valid. | lines in L1D written | |
| | | back. All lines kept | |
| | | valid L1D snoop | |
| | | invalidate. | |
| Writeback | All dirty lines in L2 | All dirty lines in L1D | All lines in L1P |
| Invalidate All | written back. All lines in | written back. All lines in | invalidated. |
| L2 | L2 invalidated. | L1D invalidated. | |

Table 1 depicts an overview of available L2 cache coherence operations. Note that these operations always operate on UP cache 203 and L1D cache 202 even if the L2 cache 200 is disabled. The cache controller 204 operates on the UP cache 203 and the L1D cache 202 in parallel (concurrently). After both operations are done, the cache controller 204 operates on L2 cache 200.

User-issued L2 cache coherence operations are required if the RISC core 102 or DSP core 106 and DMA (or other external entity) share a cacheable region of external memory, that is, if the RISC core 102 or DSP core 106 reads data written by the DMA and conversely.

The most conservative rule would be to issue a Writeback-Invalidate All prior to any DMA transfer to or from external memory. However, the disadvantage of this is that possibly more cache lines are operated on than is required, causing a larger than necessary cycle overhead. A more targeted approach is more efficient.

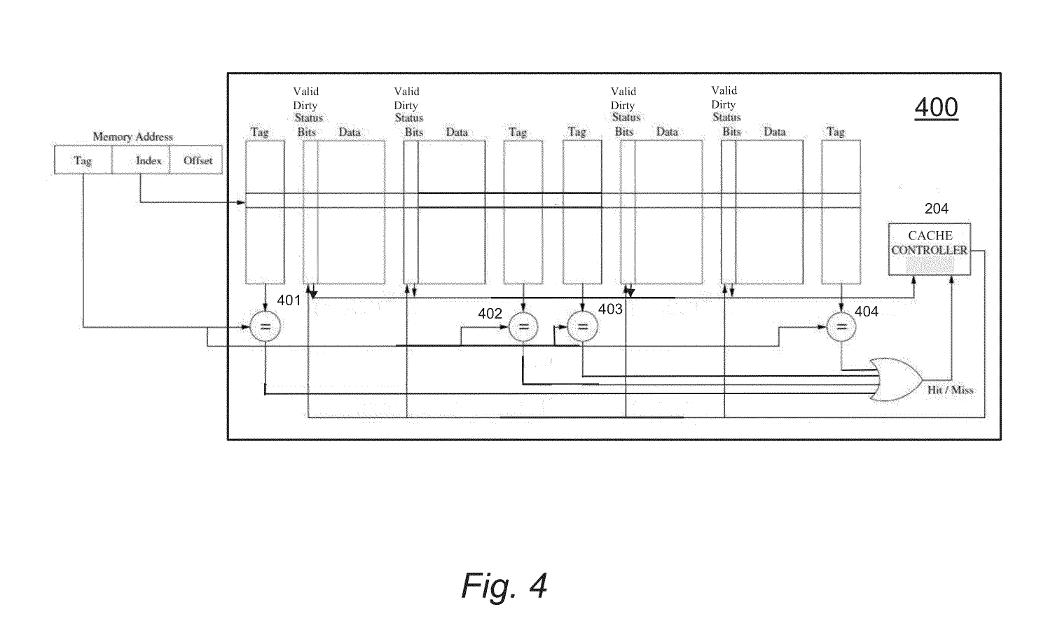

Reference is now made to FIG. 4 that depicts a cache 400 practiced in accordance with the principles of the present invention. While the cache depicted in FIG. 4 is organized as 4-way set associative, a PHOSITA will recognize that the present invention applies to caches with other number of sets without departing from the scope of the present invention.

Hits and misses are determined similar as in a direct-mapped cache, except that a tag comparison for each set is required (four tag comparisons 401, 402, 403 and 404 in the present example), to determine which set the requested data is kept. If all sets miss, the data is fetched from the next level of memory.

Cache controller 204 has inputs coupled to the valid and dirty status bits (V) and (D) from each line of each set in the cache 400. The Valid bit (V) indicates if the line is present in cache while the Dirty bit (D) indicates if that line has been modified. Generally, a cache block comprises N number of Sets where N is the associativity of the cache. The V and D status bits are stored in registers such that bits corresponding to multiple sets maybe observed substantially in parallel by the Cache controller logic 406.

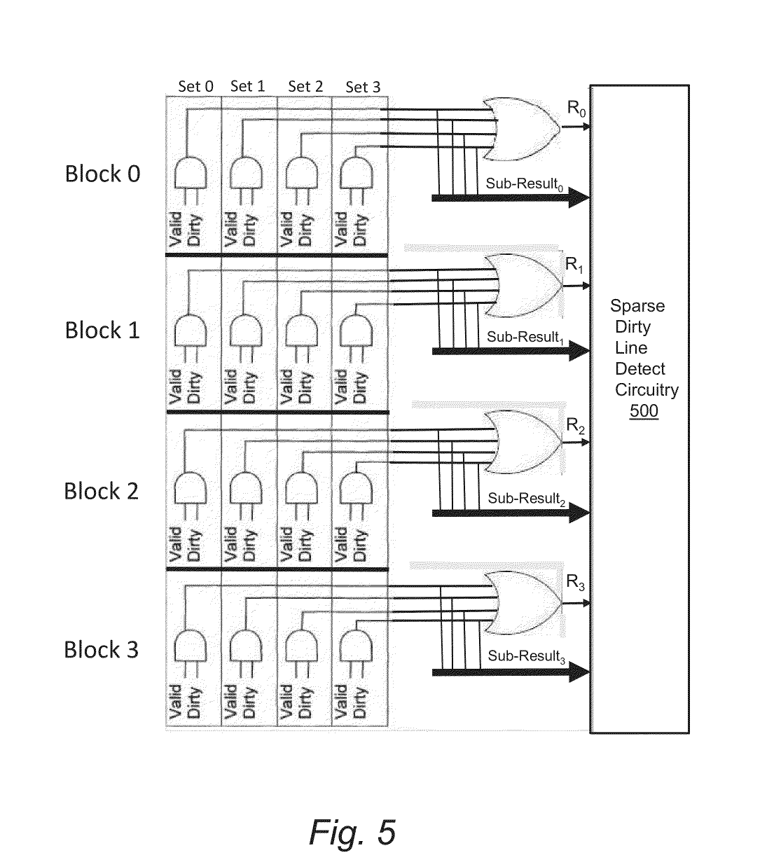

Reference is now made to FIG. 5 that illustrates a portion of cache controller 204 in accordance with the principles of the present invention. In the present example, FIG. 5 illustrates circuitry that supports a 4-way set associative cache. A PHOSITA will readily recognize other cache associativities and sizes without departing from the scope of the present invention. The Valid and Dirty status bits for each line in each set are logically AND'ed together. The AND'ed results for Set 0—Set 3 of each block (in the present example blocks 0-3) are then respectively logically OR'ed together. The results from the logical OR operations R₀-R₃ indicate whether a particular block has any dirty lines at all. If a result (i.e. R₀, R₁, R₂ or R₃) indicates that it does not have dirty lines, then that entire block can be skipped and no cache lines are written back for that particular block. If the result indicates that a block has some dirty lines, sparse dirty line detect circuitry 500 in the cache controller 204 inspects the Sub-Results (i.e. the individual logical AND'ed of Valid and Dirty bits of each set) to search and identify cache lines having corresponding valid and dirty status bits indicating that those lines need to be evicted (i.e. written back).

Sparse dirty line detect circuitry 500 has inputs coupled to the logically OR'ed output results R₀—R₃ If a result for a particular block indicates that no dirty lines exist then the Sub-Results are skipped for that block.

The logic of sparse dirty line detect circuitry 500 is best understood by example. The example assumes the entire cache is divided into 4 blocks, each with 4 sets.

```
For each block 0 to 3
  For each set 0 to 3
    Sub-Result (block)(set) = Valid (set) AND Dirty (set)
  End for
End for
If Sub-Result(block) = all zeroes -> that section has no dirty lines and can be skipped
If Sub-Result(block) = at least one -> that section has at least one dirty line and will be analyzed.
```

Sparse dirty line detect circuitry 500 searches through the Sub-Results for a leading logical 1 (the first occurrence of a logical ‘1’). The detection of a 1 indicates a dirty line that needs to be evicted. After that, search continues for the next occurrence of ‘1’—for the next dirty line until all dirty lines of a block are identified and written back.

The present invention has many applications including but not limited to, system-on-chip (SoC) streaming multimedia applications and multi-standard wireless base stations. While this disclosure has described certain embodiments and generally associated methods, alterations and permutations of these embodiments and methods will be apparent to those skilled in the art. In particular, the present invention may be used in or at any level of cache and in either a RISC or CISC processor architecture. Accordingly, the above description of example embodiments does not define or constrain this disclosure. Other changes, substitutions, and alterations are also possible without departing from the spirit and scope of this disclosure, as defined by the following claims.

What is claimed is:

1. Controller circuitry coupled to a cache having a plurality of blocks, each block having a plurality of sets with valid and dirty status bits associated with a cache line within a block, the controller circuitry comprising:
(a) logical AND circuitry having a plurality of inputs coupled to the valid and dirty bits of each set and a plurality of outputs for providing a logical AND of the valid and dirty bits of each set; and,
(b) logical OR circuitry having a plurality of inputs coupled to the plurality of outputs of the logical AND circuitry, for indicating whether a particular block has any dirty lines.

2. The controller circuitry of claim 1 wherein if the logical OR circuitry indicates that a particular block does not have dirty lines, then that particular block can skip writeback to main memory without affecting coherency, otherwise, detect circuitry checks each output of the logical AND circuitry for a particular block to identify a dirty cache line to be written back to main memory to maintain coherency.

3. The controller circuitry of claim 1 wherein the cache is an instruction cache.

4. The controller circuitry of claim 1 wherein the cache is a data cache.

5. The controller circuitry of claim 1 wherein the cache is a level one cache.

6. The controller circuitry of claim 1 wherein the cache is a level two cache.

7. A method of optimized user coherence for a cache block in a cache having a plurality of sets for holding cache lines, comprising steps of:
(a) logically AND'ing valid and dirty status bits of each set and providing a plurality of AND outputs represented thereof; and,
(b) logically OR'ing the plurality of AND outputs for indicating whether the cache block has any dirty lines.

8. The method of claim 7, wherein if the step of logically OR'ing indicates that the cache block does not have dirty lines, then the cache block is not written back to main memory without affecting coherency, otherwise, an additional step of checking each output of the step of logically AND'ing to identify a dirty cache line to be written back to main memory to maintain coherency.

9. The method of claim 7, wherein the cache is an instruction cache.

10. The method of claim 7, wherein the cache is a data cache.

11. The method of claim 7, wherein the cache is a level one cache.

12. The method of claim 7, wherein the cache is a level two cache.

13. A system comprising:
(a) a processor core; and,
(b) at least one level of cache with controller circuitry coupled to the cache having a plurality of blocks, each block having a plurality of sets with valid and dirty status bits associated with a cache line within a block, the cache controller circuitry comprising, logical AND circuitry having a plurality of inputs coupled to the valid and dirty bits of each set and a plurality of outputs for providing a logical AND of the valid and dirty bits of each set, and, logical OR circuitry having a plurality of inputs coupled to the plurality of outputs of the logical AND circuitry, for indicating whether a particular block has any dirty lines.

14. The system of claim 13 further comprising a second processor core.

15. The system of claim 13 further comprising at least one peripheral having access to the cache.

16. The system of claim 13 further comprising a second level cache.

17. The system of claim 16 wherein the second level cache further includes cache controller circuitry coupled to the second level cache having a plurality of blocks, each block having a plurality of sets with valid and dirty status bits associated with a cache line within a block, the cache controller circuitry comprising logical AND circuitry having a plurality of inputs coupled to the valid and dirty bits of each set and a plurality of outputs for providing a logical AND of the valid and dirty bits of each set; and, logical OR circuitry having a plurality of inputs coupled to the plurality of outputs of the logical AND circuitry, for indicating whether a particular block has any dirty lines.

18. The system of claim 13 further comprising a second cache.

19. The system of claim 18 wherein the first cache is an instruction cache and the second cache is a data cache.

20. The system of claim 18 wherein the processor core is a RISC core.
